(19) United States
(12) Patent Application Publication
(10) Pub. No.: US 2025/0072657 A1
(43) Pub. Date: Mar. 6, 2025

(54) BEVERAGE CONTAINER STORING DEVICE

(71) Applicants: Anthony Navarra, Hookstown, PA (US); Savanna Navarra, Monaca, PA (US)

(72) Inventors: Anthony Navarra, Hookstown, PA (US); Savanna Navarra, Monaca, PA (US)

(21) Appl. No.: 18/241,174

(22) Filed: Aug. 31, 2023

(51) Int. Cl. A47J 36/24; F25B 29/00

(52) U.S. Cl. CPC A47J 36/2433; F25B 29/00

(57) ABSTRACT

A beverage container storing device, including a main body, a cold compartment disposed within at least a portion of the main body to store at least one first item therein and generate cold air therein, a warm compartment disposed within at least a portion of the main body to store at least one second item therein, and a bottle warmer disposed on at least a portion of the main body to increase a temperature level of a bottle inserted therein.

### BACKGROUND

### 1. Field

The present general inventive concept relates generally to container storage, and particularly, to a beverage container storing device.

### 2. Description of the Related Art

Many infants require attention at varying times of the day, such as during the night and/or early in the morning. In some cases, the infant desires food. Usually, a parent will have to obtain milk that may be stored in a refrigerator located in a kitchen and then warm up the milk to a temperature that is comfortable for the infant.

However, the entire process of obtaining and warming the milk takes time away from rest and disturbs both the infant and the parents. Also, the step of warming the milk requires multiple accessories including the refrigerator and a heating device, which may be a microwave.

Therefore, there is a need for a beverage container storing device that stores a beverage as well as can quickly warm up the milk when required.

### SUMMARY

The present general inventive concept provides a beverage container storing device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a beverage container storing device, including a main body, a cold compartment disposed within at least a portion of the main body to store at least one first item therein and generate cold air therein, a warm compartment disposed within at least a portion of the main body to store at least one second item therein, and a bottle warmer disposed on at least a portion of the main body to increase a temperature level of a bottle inserted therein.

The cold compartment may include a cold storage body, and a refrigeration unit disposed within at least a portion of the cold storage body to blow air at a predetermined temperature level and keep the cold storage body cold.

The beverage container storing device may further include a temperature adjustment unit disposed on at least a portion of the main body to display a temperature level within the cold compartment and adjust the temperature level within the cold compartment based on a setting.

The beverage container storing device may further include a fast heat button disposed on at least a portion of the main body and preconfigured to set the bottle warmer to a predetermined bottle temperature level in response to being depressed.

The beverage container storing device may further include a towel rack disposed on at least a portion of the main body to receive a towel thereon.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top isometric view of a beverage container storing device, according to an exemplary embodiment of the present general inventive concept; and

FIG. 2 illustrates a front perspective view of the beverage container storing device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Beverage Container Storing Device 100
Main Body 110
Housing 111
First Portion 111a
Second Portion 111b
Feet 112
Cold Compartment 120
Cold Storage Body 121
Refrigeration Unit 122
Cold Barrier 123
Warm Compartment 130
Warm Storage Body 131
Warm Barrier 132
Bottle Warmer 140
Warm Button 141
Temperature Adjustment Unit 150
Display Unit 151
Increase Temperature Button 152
Decrease Temperature Button 153
Fast Heat Button 154
Steady Heat Button 155
Night Light 160
Power Button 170
Towel Rack 180
Power Source 190

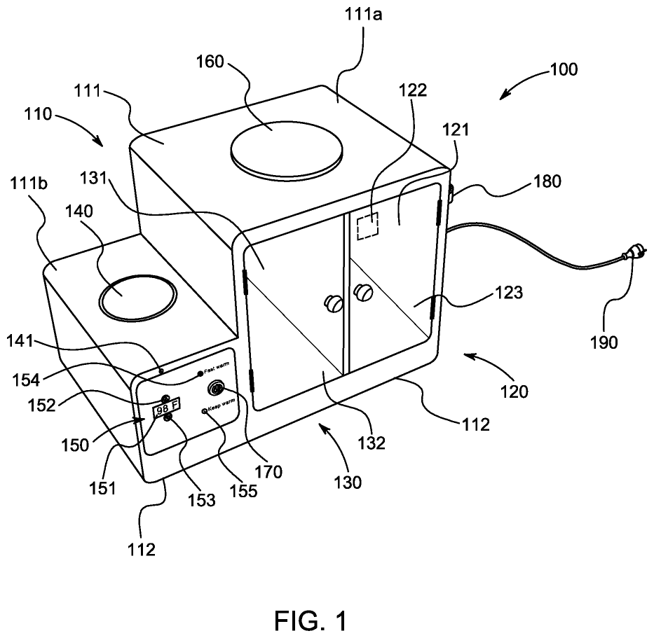

FIG. 1 illustrates a top isometric view of a beverage container storing device 100, according to an exemplary embodiment of the present general inventive concept.

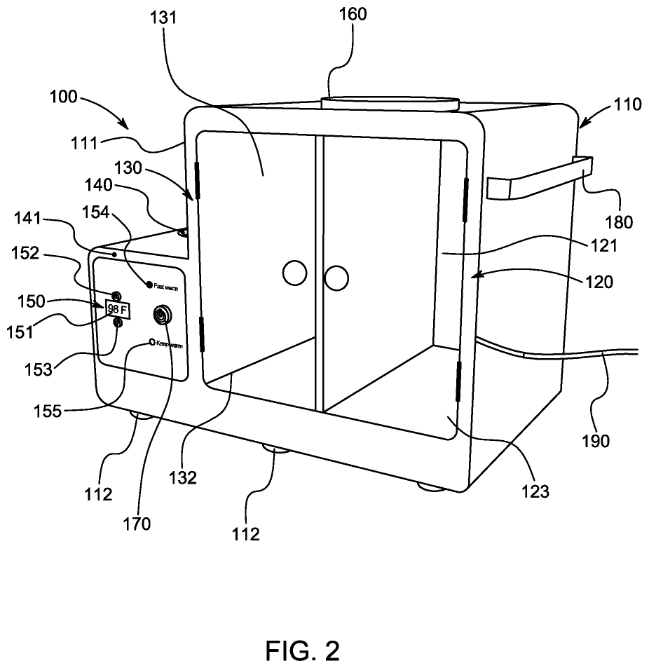

FIG. 2 illustrates a front perspective view of the beverage container storing device 100, according to an exemplary embodiment of the present general inventive concept.

The beverage container storing device 100 may be constructed from at least one of metal, plastic, wood, glass, and rubber, etc., but is not limited thereto.

The beverage container storing device 100 may include a main body 110, a cold compartment 120, a warm compartment 130, a bottle warmer 140, a temperature adjustment unit 150, a night light 160, a power button 170, a towel rack 180, and a power source 190, but is not limited thereto.

The main body 110 may be removably disposed on at least a portion of an external surface, such as a table, a desk, a countertop, a nightstand, a dresser, etc.

The main body 110 may include a housing 111 and a plurality of feet 112, but is not limited thereto.

The housing 111 may include a first portion 111a and a second portion 111b, but is not limited thereto.

Referring to FIGS. 1 and 2, the first portion 111a and the second portion 111b are illustrated to have a rounded rectangular prism shape. However, the first portion 111a and/or the second portion 111b may be rectangular, circular, cylindrical, triangular, pentagonal, hexagonal, heptagonal, octagonal, or any other shape known to one of ordinary skill in the art, but is not limited thereto. In other words, the first portion 111a may have a different shape from the second portion 111b.

The first portion 111a may have a size (e.g., a length, a width, a height) equivalent to or greater than a size (e.g., a length, a width, a height) of the second portion 111b.

The plurality of feet 112 may be disposed on at least a portion of a base of the housing 111. Moreover, the plurality of feet 112 may prevent the housing 111 from contacting the external surface, while the housing 111 is disposed on the external surface. As such, the plurality of feet 112 may protect the housing 111 from damage due to contact with the external surface.

The cold compartment 120 may include a cold storage body 121, a refrigeration unit 122, and a cold barrier 123, but is not limited thereto.

The cold storage body 121 may be disposed within at least a portion of the housing 111. The cold storage body 121 may be constructed to be insulation material, such as a polyurethane foam, a rubber foam, and a cold foam sealant chemical. As such, the cold storage body 121 may maintain a low temperature (i.e., cold, forty degrees Fahrenheit). Also, the cold storage body 121 may prevent an increase in a temperature level therein. The cold storage body 121 may store at least one first item therein. For example, the cold storage body 121 may store a baby bottle containing a beverage, such as milk.

The refrigeration unit 122 may include a condenser, a fan, and a refrigerant/coolant therein, but is not limited thereto.

The refrigeration unit 122 may be disposed within at least a portion of the cold storage body 121. The refrigeration unit 122 may generate cold air within the cold storage body 121. Therefore, the refrigeration unit 122 may blow air at a predetermined temperature level (e.g., forty degrees Fahrenheit) to keep the cold storage body cold 121. Alternatively, the refrigeration unit 122 may be adjusted (e.g., using a switch) to a lower temperature level or a higher temperature level than the predetermined temperature level based on a preference of a user.

The cold barrier 123 may be movably (i.e., hingedly, pivotally, rotatably) disposed on at least a portion of the cold storage body 121. The cold barrier 123 may move (i.e., pivot, rotate) from closed against the cold storage body 121 in a first position to at least partially opened away from the cold storage body 121 in a second position. Conversely, the cold barrier 123 may move from opened away from the cold storage body 121 in the second position to closed against the cold storage body 121 in the first position. In other words, the cold barrier 123 may prevent access within the cold storage body 121 in the first position and allow access within the cold storage body 121 in the second position.

The warm compartment 130 may include a warm storage body 131 and a warm barrier 132, but is not limited thereto.

The warm storage body 131 may be disposed within at least a portion of the housing 111. The warm storage body 131 may store at least one second item therein. For example, the warm storage body 131 may store a water bottle. Also, unlike the cold storage body 121, the warm storage body 131 may keep the at least one second item and/or any other contents at a room temperature. In other words, the warm storage body 131 is not insulated and does not prevent an increase and/or a decrease in the temperature level.

Furthermore, the warm storage body 131 may be separated from the cold storage body 121.

The warm barrier 132 may be movably (i.e., hingedly, pivotally, rotatably) disposed on at least a portion of the warm storage body 131. The warm barrier 132 may move (i.e., pivot, rotate) from closed against the warm storage body 131 in a first position to at least partially opened away from the warm storage body 131 in a second position. Conversely, the warm barrier 132 may move from opened away from the warm storage body 131 in the second position to closed against the warm storage body 131 in the first position. In other words, the warm barrier 132 may prevent access within the warm storage body 131 in the first position and allow access within the warm storage body 131 in the second position.

The bottle warmer 140 may include a heating coil and an induction heater, but is not limited thereto. Furthermore, the bottle warmer 140 may include a warm button 141, but is not limited thereto.

The bottle warmer 140 may be disposed on at least a portion of a top side of the second portion 111b. The bottle warmer 140 may have a size (e.g., a diameter, a circumference) corresponding to a size (e.g., a diameter, a circumference) of a bottle. The bottle warmer 140 may increase the temperature level therein and/or increase a temperature level of at least one object (e.g., the bottle) inserted therein. Thus, for example, the bottle warmer 140 may be used to increase the temperature level (i.e., heat up) the bottle with milk.

The warm button 141 may be disposed on at least a portion of the second portion 111b. The bottle warmer 140 may turn on in response to depressing the warm button 141 a first time. Conversely, the bottle warmer 140 may turn off in response to depressing the warm button 141 a second time.

The temperature adjustment unit 150 may include a display unit 151, an increase temperature button 152, a decrease temperature button 153, a fast heat button 154, and a steady heat button 155, but is not limited thereto.

The display unit 151 may include a plasma screen, an LCD screen, a light emitting diode (LED) screen, an organic LED (OLED) screen, a computer monitor, a hologram output unit, a sound outputting unit, or any other type of device that visually or aurally displays data.

The display unit 151 may be disposed on at least a portion of the second portion 111b. The display unit 151 may display the temperature level of the cold storage body 121 and/or the refrigeration unit 122.

The increase temperature button 152 may be disposed on at least a portion of the second portion 111b. The increase temperature button 152 may increase the temperature level (i.e., change a setting) of the cold storage body 121 and/or the refrigeration unit 122 in response to being depressed.

The decrease temperature button 153 may be disposed on at least a portion of the second portion 111b. The decrease temperature button 153 may decrease the temperature level of the cold storage body 121 and/or the refrigeration unit 122 in response to being depressed.

The fast heat button 154 may be disposed on at least a portion of the second portion 111b and/or connected to the bottle warmer 140. The fast heat button 154 may be preconfigured to set the bottle warmer 140 to a predetermined bottle temperature level (e.g., ninety-eight point six (98.6) degrees Fahrenheit). As such, the bottle warmer 140 may increase the temperature level therein and/or increase the temperature level of the at least one object inserted therein to the predetermined bottle temperature level in response to depressing the fast heat button 154.

The steady heat button 155 may be disposed on at least a portion of the second portion 111b and/or connected to the bottle warmer 140. The steady heat button 155 may be preconfigured to maintain the bottle warmer 140 at the predetermined bottle temperature level. For example, the steady heat button 155 may be depressed to prevent the temperature level of the bottle warmer 140 from fluctuating after it has been warmed up.

The night light 160 may include an incandescent bulb, a light-emitting diode (LED), a xeon bulb, a fluorescent bulb, and a halogen lamp, but is not limited thereto.

The night light 160 may be disposed on at least a portion of the first portion 111a. The night light 160 may illuminate in response to being depressed a first time. Conversely, the night light 160 may turn off in response to being depressed a second time.

The power button 170 may be disposed on at least a portion of the second portion 111b. The power button 170 may turn on the cold compartment 120, the bottle warmer 140, the temperature adjustment unit 150, and/or the night light 160 in response to being depressed a first time. Conversely, the power button 170 may turn off the cold compartment 120, the bottle warmer 140, the temperature adjustment unit 150, and/or the night light 160 in response to being depressed a second time.

The towel rack 180 may be disposed on at least a portion of the first portion 111a. The towel rack 180 may receive and/or store a towel thereon.

The power source 190 may include a power inlet, a battery, and a solar cell, but is not limited thereto.

The power source 190 may be disposed on at least a portion of the first portion 111a and/or the second portion 111b. The power source 190 may provide power to the cold compartment 120, the bottle warmer 140, the temperature adjustment unit 150, the night light 160, and/or the power button 170.

Therefore, the beverage container storing device 100 may store the at least one first item and/or the at least one second item for quick access for an infant, such as in a nursery and/or a baby room. Also, the beverage container storing device 100 may provide bottle warming without having to use another device.

The present general inventive concept may include a beverage container storing device 100, including a main body 110, a cold compartment 120 disposed within at least a portion of the main body 110 to store at least one first item therein and generate cold air therein, a warm compartment 130 disposed within at least a portion of the main body 110 to store at least one second item therein, and a bottle warmer 140 disposed on at least a portion of the main body 110 to increase a temperature level of a bottle inserted therein.

The cold compartment 120 may include a cold storage body 121, and a refrigeration unit 122 disposed within at least a portion of the cold storage body 121 to blow air at a predetermined temperature level and keep the cold storage body 121 cold.

The beverage container storing device 100 may further include a temperature adjustment unit 150 disposed on at least a portion of the main body 110 to display a temperature level within the cold compartment 120 and adjust the temperature level within the cold compartment 120 based on a setting.

The beverage container storing device 100 may further include a fast heat button 154 disposed on at least a portion of the main body 110 and preconfigured to set the bottle warmer 140 to a predetermined bottle temperature level in response to being depressed.

The beverage container storing device 100 may further include a towel rack 180 disposed on at least a portion of the main body 110 to receive a towel thereon.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A beverage container storing device, comprising:
a main body;
a cold compartment disposed within at least a portion of the main body to store at least one first item therein and generate cold air therein;
a warm compartment disposed within at least a portion of the main body to store at least one second item therein; and
a bottle warmer disposed on at least a portion of the main body to increase a temperature level of a bottle inserted therein.

2. The beverage container storing device of claim 1, wherein the cold compartment comprises:
a cold storage body; and
a refrigeration unit disposed within at least a portion of the cold storage body to blow air at a predetermined temperature level and keep the cold storage body cold.

3. The beverage container storing device of claim 1, further comprising:
a temperature adjustment unit disposed on at least a portion of the main body to display a temperature level within the cold compartment and adjust the temperature level within the cold compartment based on a setting.

4. The beverage container storing device of claim 1, further comprising:
a fast heat button disposed on at least a portion of the main body and preconfigured to set the bottle warmer to a predetermined bottle temperature level in response to being depressed.

5. The beverage container storing device of claim 1, further comprising:
a towel rack disposed on at least a portion of the main body to receive a towel thereon.
